(19) United States
(12) Patent Application Publication
(10) Pub. No.: US 2009/0110953 A1
(43) Pub. Date: Apr. 30, 2009

(54) METHOD OF TREATING A THERMAL BARRIER COATING AND RELATED ARTICLES

(75) Inventor: Joshua L. Margolies, Niskayuna, NY (US)

Correspondence Address: CANTOR COLBURN, LLP, 20 Church Street, 22nd Floor, Hartford, CT, 06103, US

(73) Assignee: General Electric Company, Schenectady, NY (US)

(21) Appl. No.: 11/926,690

(22) Filed: Oct. 29, 2007

(51) Int. Cl. B21D 39/00; B05D 3/00

(52) U.S. Cl. 428/621; 427/299; 427/314; 427/383.1

(57) ABSTRACT

A method of treating a thermal barrier coating comprises applying a dopant composition to a selected surface of the thermal barrier coating disposed on a turbine engine part, and heating the surface to form an enhanced thermal barrier coating. The dopant composition comprises a rare earth metal compound.

### BACKGROUND OF THE INVENTION

This disclosure relates to a method of treating a thermal barrier coating, and related articles.

Thermal barrier coatings (TBC's) protect components operating in the gas path environment of turbine engines and other power generation turbines, where they are exposed to significant temperature extremes and associated oxidizing and corrosive conditions. Examples of turbine engine parts and components for which such a TBC is desirable include turbine blades and vanes, turbine shrouds, buckets, nozzles, combustion liners and deflectors, and the like.

TBC's are usually deposited onto desired surfaces of a metal substrate (which may include a bond coat layer to provide for better adherence of the TBC to the metal surfaced) from which the part or component is formed. The low thermal conductivity of the TBC reduces heat flow to the underlying metal substrate (i.e., provides thermal insulation). The metal substrate typically comprises a metal alloy such as a nickel, cobalt, and/or iron based alloy (e.g., a high temperature superalloy).

TBCs are subject to the following modes of failure during their service life: spallation following thermo-mechanical strain, erosive removal of the coating, increased thermal conductivity reducing coating effectiveness, and delamination following CMAS infiltration. CMAS refers to mixed environmental contaminants of calcium-magnesium-aluminum-silicon-oxide systems (Ca—Mg—Al—SiO) that can penetrate TBCs and lead to cracking or spallation of the protective layer(s). Increased thermal conductivity results in more heat reaching the protected part, requiring equipment to be operated at less efficient lower temperatures. Loss of mechanical durability can lead to erosion/impact damage and overall high temperature failure of the TBC. Service temperature can serve to cause a crystal structure change of the TBC to a less durable one, for example from tetragonal to cubic.

The cubic phase is 8 times more susceptible to erosion, and has demonstrated reduced spallation resistance.

A thermal barrier layer (TBC), such as those used to protect components of turbine engines, typically has a service life of approximately 24,000 hours operation. In that time many inspections are conducted. The current practice is to physically swap out parts if a TBC shows evidence of weakening, such as cracks, spallation, delamination, or exposed substrate. Exchanging parts is costly in both parts and down time.

Current focus in improving TBCs is on advancements in new TBC layers, principally in the chemical composition of the TBC or bonding layers, TBC layer structure, and coating conditions.

Currently, there is no practice of, or method for, improving the performance of a TBC during its service life; however, such a method is attractive for its potentially significant cost benefits. Thus, a means was sought for enhancing TBCs that improves TBC performance relative to one of the described failure modes and extends the useful lifetime of coated parts.

### BRIEF DESCRIPTION OF THE INVENTION

Disclosed herein are methods of treating a thermal barrier layer on turbine engine parts that extends the useful life of the parts.

In one embodiment, a method of treating a thermal barrier coating comprises applying a dopant composition to a selected surface of the thermal barrier coating disposed on a turbine engine part, and heating the surface to form an enhanced thermal barrier coating. The dopant composition comprises a rare earth metal compound.

In another embodiment, an article comprises an enhanced thermal barrier layer formed by the disclosed method.

The features and advantages of the method of enhancing a barrier layer may be more readily understood by reference to the following figure and detailed description.

### BRIEF DESCRIPTION OF THE DRAWINGS

Turning now to the figures wherein like elements are numbered alike:

FIG. 1 is a schematic illustrating the process of treating a TBC wherein a defect crack does not expose the substrate surface.

FIG. 2 is a schematic illustrating the process of treating a TBC wherein a defect crack exposes the substrate surface.

### DETAILED DESCRIPTION OF THE INVENTION

Disclosed herein is a method of treating a thermal barrier coating that improves on TBC performance with respect to at least one of CMAS resistance, mechanical durability, and thermal conductivity of the TBC. A treated TBC is also referred to herein as an enhanced TBC. An enhanced TBC has at least one of lower thermal conductivity, greater mechanical durability, greater CMAS resistance, or combinations thereof relative to the pre-treated TBC.

The TBC treatment is contemplated as more than a repair process. Improved TBC performance permits more efficient engine operation, including extended operating times between swapped parts, and potentially reduces overall maintenance costs.

An additional important benefit of the treatment relates to TBC compositions comprising yttria-stabilized-zirconia, particularly 7YSZ, having an yttria content of about 6 to about 8 weight percent based on the total weight of the yttria-stabilized-zirconia. 7YSZ is a widely used TBC material due at least in part to its high temperature durability, low thermal conductivity, and relative ease of deposition. 7YSZ undergoes a phase transformation from tetragonal to cubic at elevated temperatures over prolonged time scale. The cubic phase is much softer. The disclosed method of treatment restabilizes the more mechanically durable tetragonal phase.

In one embodiment, the method of treating a TBC such as one that is disposed on a turbine engine part comprises applying a dopant composition comprising a rare earth metal compound to a selected surface of the TBC at least once during the part's service life. The selected surface of the TBC can optionally be cleaned before the treatment. As will be discussed in greater detail below, the dopant composition can be in the form of a solution, solid particle dispersion in organic solvent, solid particle dispersion in water, mixed organic and aqueous liquid dispersion, powder, paste, gel, or semi-solid (wax) at ambient temperature. The applied dopant composition is dried and optionally heated to promote diffusion of the rare earth metal dopant into the TBC.

The part can comprise any metal substrate, in particular the metal substrates commonly used in turbine engines. The metal substrates typically comprise a metal alloy such as a nickel, cobalt, and/or iron based alloy (e.g., a high temperature superalloy).

The part can further comprise a bond coat layer between the metal surface and the TBC, or the TBC can be disposed directly on the surface of the part. The optional bond coat layer can comprise any composition known in the art for adhering a thermal barrier coating to a metal substrate. Bond coat layers typically are metallic oxidation-resistant materials including MCrAlY alloy powders, where M represents a metal such as iron, nickel, platinum or cobalt, in particular, various metal aluminides such as nickel aluminide and platinum aluminide.

The TBC and optional bond coat layer can comprise one or more layers formed by known methods of coating including plasma spraying including air plasma spray (APS) and vacuum plasma spray (VPS), or other thermal spray deposition methods such as high velocity oxy-fuel (HVOF) spray, detonation, or wire spray, chemical vapor deposition (CVD), and physical vapor deposition (PVD) such as electron beam physical vapor deposition (EBPVD), and like techniques.

The TBC and optional bond coat layer can have any thickness. Usually, the deposited bond coat layer has a thickness in the range of from about 25 to about 495 micrometers (about 1 to about 19.5 mils). More particularly, bond coat layers deposited by PVD techniques such as EBPVD have a thickness in the range of about 25 to about 76 micrometers (about 1 to about 3 mils). For bond coat layers deposited by plasma spray techniques such as APS, the thickness is more typically in the range of about 76 to about 381 micrometers (about 3 to about 15 mils).

The TBC can comprise any chemical composition known in the art for thermal barrier coatings. These include various ceramic materials such as zirconia (ZrO₂), yttria (Y₂O₃, yttrium oxide), magnesia (MgO, magnesium oxide), ceria (CeO₂, cerium oxide), In₂O₃ (indium oxide, india), La₂O₃ (lanthanum oxide, lanthana), Pr₂O₃ (praesodymium oxide, praesodymia), Nd₂O₃ (neodymium oxide, neodymia), Sm₂O₃ (samarium oxide, samaria), Eu₂O₃ (europium oxide, europia), Gd₂O₃ (gadolinium oxide, gadolinia), Tb₂O₃ (terbium oxide, terbia), Dy₂O₃ (dysprosium oxide, dysprosia), Ho₂O₃ (holmium oxide, holmia), Er₂O₃ (erbium oxide, erbia), Tm₂O₃ (thulium oxide, thulia), Yb₂O₃ (ytterbium oxide, ytterbia), Lu₂O₃ (lutetium oxide, lutetia), Sc₂O₃ (scandium oxide, scandia), MgO (magnesium oxide, magnesia), and CaO (calcium oxide, calcia), TiO₂ (titanium dioxide, titania), Ta₂O₅ (tantalum pentoxide, tantala) and combinations comprising at least of one of the foregoing ceramic materials.

In one embodiment, the TBC comprises zirconias stabilized by a metal oxide selected from yttria, dysprosia, erbia, europia, gadolinia, neodymia, praseodymia, urania, and hafnia and combinations thereof. In another embodiment, the TBC comprises an yttria-stabilized-zirconia wherein the yttria is in an amount of six to eight weight percent yttria based on the total weight of the yttria-stabilized-zirconia.

The TBC can further comprise other additives, in particular pyrochlores of the general composition A₂B₂O₇ where A is a metal having a valence of 3+ or 2+ (e.g., gadolinium, aluminum, cerium, lanthanum or yttrium) and B is a metal having a valence of 4+ or 5+ (e.g., hafnium, titanium, cerium or zirconium) where the sum of the A and B valences is 7. Representative materials of this type include, in addition to gadolinium zirconate (Gd-zirconate or GdZ), lanthanum titanate, lanthanum zirconate, yttrium zirconate, lanthanum hafnate, cerium zirconate, aluminum cerate, cerium hafnate, aluminum hafnate and lanthanum cerate.

The surface of the TBC can be cleaned by any method suitable for removing particulate and non-particulate matter such as grease, carbonaceous deposits, dirt, oil, and other matter, to provide a surface at least partially penetrable by at least one component of the enhancing composition.

The TBC is treated with a dopant composition comprising a rare earth metal compound, for example, zirconia, yttria, magnesia, ceria, india, lanthana, praesodymia, neodymia, samaria, europia, gadolinia, terbia, dysprosia, holmia, erbia, thulia, ytterbia, lutetia, scandia, magnesia, calcia, and combinations comprising at least of one of the foregoing rare earth metal compounds. In another embodiment, the dopant composition comprises zirconias stabilized by yttria, dysprosia, erbia, europia, gadolinia, neodymia, praseodymia, urania, hafnia and combinations thereof. More specifically, the dopant composition comprises at least one rare earth metal oxide or a chemical equivalent selected from the group consisting of lanthana, titania, ytterbia, gadolinia, and combinations comprising at least one of the foregoing metal oxides. A chemical equivalent of a rare earth metal oxide can react to form the rare earth metal oxide when exposed to air or moisture after the dopant composition is applied to the TBC surface. In another embodiment, the dopant composition comprises an yttria-stabilized-zirconia wherein the yttria content is six to eight weight percent based on the total weight of the yttria-stabilized-zirconia; that is, 7YSZ.

The dopant composition can further comprise pyrochlore additives as described above, including gadolinium zirconate, lanthanum titanate, lanthanum zirconate, yttrium zirconate, lanthanum hafnate, cerium zirconate, aluminum cerate, cerium hafnate, aluminum hafnate, lanthanum cerate, and combinations thereof.

7YSZ undergoes a phase transformation from tetragonal to cubic at elevated temperatures over a prolonged time scale. The cubic phase is much softer. In one embodiment, a dopant composition comprises titanium or tantalum compositions to re-stabilize the 7YSZ tetragonal phase. An exemplary dopant composition comprises a mixture of metal oxides including about 4 weight percent to about 15 weight percent titania/tantala (TiO₂/Ta₂O₅), about 7 weight percent yttria (Y₂O₃), and the balance zirconia (ZrO₂) based on total weight of the metal oxides.

The dopant composition can have the form of a solution, solid particle dispersion in organic solvent, solid particle dispersion in water, mixed organic and aqueous liquid dispersion, powder, paste, gel, or semi-solid (wax) at ambient temperature. More particularly, the dopant composition can be prepared by, for example, dissolving the additive metal in an acid, such as nitric acid, forming a metal salt. The particles are molecules only a few atomic diameters in scale. Alternatively, the dopant composition can be prepared by suspending nanometer sized particles in a solvent such as an alcohol. In dispersed form, the dopant particles have a median size ranging from about 0.5 nanometers to about 10 nanometers.

Particularly desirable forms of the dopant composition are those that can be applied as in the manner of a paint using any known applicators for liquid media, including brush, roller, sponge, cloth, manual sprayer, powered sprayer, aerosol sprayer, and the like. Highly viscous, semi-solid, or solid forms of the dopant composition can be applied by any means known in the art including manually rubbing, injecting as with a caulking gun, or applying by means of a trowel, putty knife, powder applicator, cloth, and the like.

In one embodiment, the dopant composition is heated prior to applying it to the TBC; for example, to enhance flow properties of the dopant composition. In another embodiment, the dopant composition is heated after applying it and before operating the turbine engine; for example, to promote evaporation of a solvent, or increase penetration of the dopant into the TBC. Alternatively, the dopant treated area can be allowed to dry under ambient conditions. Applied dopant compositions comprising curable components can be cured by known methods including ambient curing by exposure to air, curing at elevated temperature, or curing by exposing the applied dopant composition to a form of radiant energy including x-ray, microwave, ultraviolet, visible, and infrared radiation.

In another embodiment, multiple layers of dopant composition are applied to a selected area of the TBC, allowing each layer to dry or cure before applying a subsequent layer. In still another embodiment, the multiple layers comprise different dopant compositions.

The dopant composition can further comprise a solvent that can evaporate at ambient or slightly elevated temperatures. The solvent can be organic, aqueous or a combination thereof, including lower chain, branched and cyclic hydrocarbons, aromatic hydrocarbons, ethers, polyethers, cyclic ethers, esters, ketones, alcohols, and the like. More specifically the solvent can be methylene chloride, chloroform, pentane, cyclopentane, hexane, cyclohexane, benzene, toluene, petroleum ether, heptane, cycloheptane, octane, cyclooctane, water, methanol, ethanol, propanol, iso-propanol, butanol, sec-butanol, tert-butanol, acetone, diethyl ether, ethyl acetate, propyl acetate, isopropyl acetate, butyl acetate, and combinations including at least one of the foregoing solvents.

The dopant composition can further comprise other additives including surfactants, antioxidants, oils, penetrants, and resins.

The dopant composition is applied to a selected surface of the TBC on at least one turbine engine part. The part can be uninstalled or remain installed before applying the dopant composition. The dopant composition is applied at least once during the service life of the part. The dopant composition can be applied at any time during the service life of the part, particularly during service inspections.

The dopant composition can be applied to selected or all portions of the TBC surface of the part, and in particular to areas of the TBC surface that show erosion, cracks or other defects after initial operation. TBC's contain many micro-cracks when new, by design. Due to the thermal expansion mis-match between the TBC ceramic and the metal substrate, these micro-cracks are essential to permit strain compliance upon heating and cooling. It is through this existing micro-crack network that the dopant can infiltrate the coating.

The dopant composition can be applied at any temperature. In one embodiment, a portion of the applied dopant composition is applied at ambient temperature to the porous surface of the TBC. The applied dopant diffuses into the TBC of the installed part at elevated temperature during operation of the turbine engine. The temperature required for diffusion is generally greater than about 550° C. (>1000° F.). In another embodiment the selected surface of the TBC is heated prior to application of the dopant composition in order to open up the micro-cracks and increase initial penetration depth of the dopant composition.

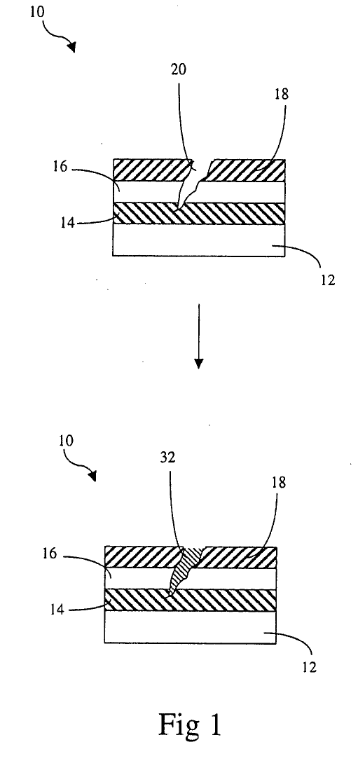

Turning now to the figures, FIG. 1 is a schematic representing a non-limiting example for treating a TBC with a defect crack within the TBC that does not extend to the surface of the substrate on which the TBC is disposed. The article, generally represented by reference numeral 10, includes a substrate 12, and a multilayer TBC coating having a defect crack 20. The multilayer TBC includes layers 14, 16, and 18, wherein article 10 has no bond coat layer; or alternatively, layer 14 can represent a bond coat layer, wherein the TBC comprises layers 16 and 18. The number of layers in the TBC is for illustration and not meant to be limiting. Following treatment of article 10 with a dopant composition, the defect crack 20 becomes filled with dopant as represented by filled defect crack 32. Without being limited by theory, the applied dopant is believed to penetrate the areas of the TBC surrounding the defect crack, thus strengthening the TBC.

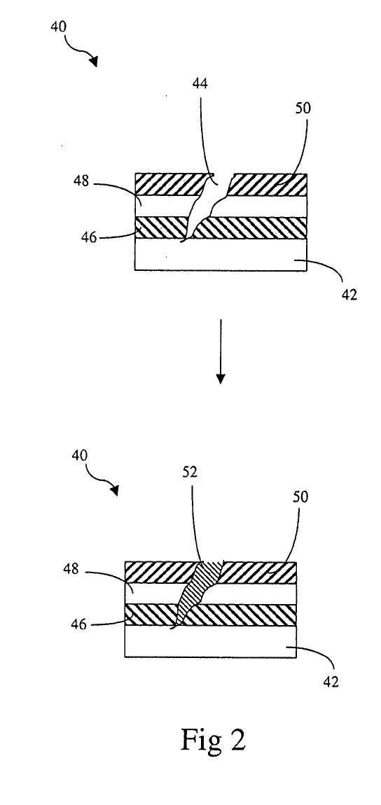

FIG. 2 is a schematic representing another non-limiting example for treating a TBC with a defect crack within the TBC that does extend to the surface of the substrate on which the TBC is disposed. The article 40 includes a substrate 42, and defect crack 44 in the TBC extending to a surface of the substrate 42. As in FIG. 1, the TBC includes multiple layers 46, 48, and 50, wherein article 40 has no bond coat layer; or alternatively, layer 46 can represent a bond coat layer, wherein the TBC comprises layers 48 and 50. Following treatment of article 40 with a dopant composition, the defect crack 42 becomes filled with dopant as represented by filled defect crack 52.

The applied dopant compositions are effective in enhancing at least one of the thermal barrier properties of the TBC. The thermal barrier properties include thermal conductivity, mechanical durability, and CMAS resistance (resistance to environmental contaminants known as calcium-magnesium-aluminum-silicon-oxides, or CMAS). Thus, the methods disclosed herein enhance TBC performance by lowering thermal conductivity, increasing mechanical durability, increasing CMAS resistance, or combinations of the foregoing properties relative to the pre-treated TBC.

Using the described methods, applied rare earth dopants on the TBC have been found to extend the life of existing parts and reduce the time associated with an equipment outage. At least one of the modes of failure including CMAS resistance, thermal conductivity, and high temperature durability are improved by this treatment.

The singular forms “a,” “an,” and “the” include plural referents unless the context clearly dictates otherwise. The endpoints of all ranges directed to the same characteristic or component are independently combinable and inclusive of the recited endpoint.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method, comprising:
applying a dopant composition to a selected surface of a thermal barrier coating disposed on a turbine engine part, the dopant composition comprising a rare earth metal compound, and
heating the surface to form an enhanced thermal barrier coating.

2. The method of claim 1, wherein the thermal barrier coating comprises one or more layers of a rare earth metal compound selected from the group consisting of zirconia, yttria, magnesia, ceria, india, lanthana, praesodymia, neodymia, samaria, europia, gadolinia, terbia, dysprosia, holmia, erbia, thulia, ytterbia, lutetia, scandia, magnesia, calcia, and combinations comprising at least of one of the foregoing rare earth compounds.

3. The method of claim 1, wherein the thermal barrier coating comprises one or more layers of a zirconia stabilized by a metal oxide selected from the group consisting of yttria, dysprosia, erbia, europia, gadolinia, neodymia, praseodymia, urania, hafnia and combinations thereof.

4. The method of claim 1, wherein the thermal barrier coating comprises one or more layers of an yttria-stabilized-zirconia wherein the yttria content is six to eight weight percent based on the total weight of the yttria-stabilized-zirconia.

5. The method of claim 1, wherein the thermal barrier coating comprises one or more layers of a rare earth metal oxide or a chemical equivalent of a rare earth metal oxide selected from the group consisting of lanthana, titania, ytterbia, gadolinia, and combinations comprising at least one of the foregoing metal oxides.

6. The method of claim 1, further comprising evaporating a solvent after applying, wherein the dopant composition comprises the solvent.

7. The method of claim 1, wherein the dopant composition comprises a rare earth metal compound selected from the group consisting of zirconia, yttria, magnesia, ceria, india, lanthana, praesodymia, neodymia, samaria, europia, gadolinia, terbia, dysprosia, holmia, erbia, thulia, ytterbia, lutetia, scandia, magnesia, calcia, and combinations comprising at least of one of the foregoing rare earth compounds.

8. The method of claim 1, wherein the dopant composition comprises zirconia stabilized by a metal oxide selected from the group consisting of yttria, dysprosia, erbia, europia, gadolinia, neodymia, praseodymia, urania, hafnia and combinations thereof.

9. The method of claim 1, wherein the dopant composition comprises an yttria-stabilized-zirconia, wherein the yttria content is six to eight weight percent based on the total weight of the yttria-stabilized-zirconia.

10. The method of claim 1, wherein the dopant composition comprises a rare earth metal oxide or a chemical equivalent of a rare earth metal oxide selected from the group consisting of lanthana, titania, ytterbia, gadolinia, tantala and combinations comprising at least one of the foregoing metal oxides.

11. The method of claim 1, wherein the dopant composition comprises a mixture of metal oxides including about 4 weight percent to about 15 weight percent titania/tantala, about 7 weight percent yttria, and the balance zirconia based on total weight of the metal oxides.

12. The method of claim 1, wherein the thermal barrier coating after applying the dopant composition has a selected one of lower thermal conductivity, greater mechanical durability, greater CMAS resistance, or combinations thereof relative to the pre-treated thermal barrier coating.

13. The method of claim 1, further comprising heating the dopant composition or the selected surface before applying.

14. The method of claim 1, wherein the dopant composition is one of a solution, solid particle dispersion in organic solvent, solid particle dispersion in water, mixed organic and aqueous liquid dispersion, powder, paste, gel, or semi-solid at ambient temperature.

15. The method of claim 1, wherein applying the dopant composition is by means of a brush, roller, sponge, cloth, manual sprayer, powered sprayer, aerosol sprayer, manual rubbing, injecting, trowel, putty knife, powder applicator, immersion, or combinations thereof.

16. The method of claim 1, wherein applying is repeated with a plurality of dopant compositions.

17. The method of claim 1, further comprising cleaning the surface of before applying.

18. The method of claim 1, wherein the part is selected from a blade, vane, shroud, bucket, nozzle, combustion liner, deflector, or combination thereof.

19. An article comprising an enhanced thermal barrier layer formed by applying a dopant composition to a selected surface of a thermal barrier coating disposed on a part of a turbine engine, the dopant composition comprising a rare earth metal compound, and heating the surface to form the enhanced thermal barrier layer.

20. The article of claim 19, comprising a part for a turbine engine selected from blade, vane, shroud, bucket, nozzle, combustion liner, deflectors, or combinations thereof.
